(19) United States
(12) Patent Application Publication
(10) Pub. No.: US 2006/0285918 A1
(43) Pub. Date: Dec. 21, 2006

(54) Method for the production of connection systems, and connection systems produced according to said method

(76) Inventors: Jean-Jacques Legat, Colombe (FR); Jerome Blanc, Saint Martin le Vinoux (FR)

Correspondence Address: John R Hlavka;Watts Hoffman, P O Box 99839, Cleveland, OH, 44199-0839, US

(21) Appl. No.: 10/559,299

(22) PCT Filed: Apr. 14, 2004
(86) PCT No.: PCT/EP04/03909

§ 371 Date: Jul. 3, 2006

(30) Foreign Application Priority Data
Apr. 30, 2003 (DE) 10319756.7

(51) Int. Cl. F16B 21/08

(52) U.S. Cl. 403/397

(57) ABSTRACT

Disclosed is a novel method for producing connection systems consisting of at least two plastic parts which are functionally movable relative to each other in a rotating manner. According to said method, the inner (1; 15) of the two parts (1, 2; 15, 16) that are rotationally movable relative to each other is first cast or injected from a plastic material in a mold, whereupon the outer (2;16) of the two parts (1, 2; 15, 16) that are rotationally movable relative to each other is cast or injected from a different plastic material over the inner part (1; 15). The inner part (1; 15) or at least one portion thereof is used as a core for the outer part, the two materials which are used for the inner and the outer part not being adhesive or sticking to each other. Such a connection system is provided with a pin part (2) comprising a pin (11), and an anchor part (1) comprising claws (5) that are forced apart by twisting the pin (11), for example. The pin part (2) is used as a core for the anchor part (1) during the production process.

The invention relates to a method for the production of connection systems consisting of at least two plastic parts which are functionally movable relative to each other in a rotating manner, and connection systems produced according to said method for the detachable connection of two components.

For the case in which components are to be connected to each other but, as is often required, a detaching and restoring of the connection is to be possible with no danger of damaging the components and the connecting means, up to now there have been connection systems that consist of at least two separate parts that have to be assembled and brought into functional engagement each time in order to produce a connection, but which thereafter can also be detached from each other again and reused to again produce the same connection or for the production of another connection of the same type, e.g., screws and nuts.

The disadvantage of such connection systems is that they can be used only at connecting locations that are accessible on both sides of the components to be connected after they have been brought into position. The bringing together of both parts of the connection system when doing this is laborious and time-consuming, which also has a negative effect on the costs for the end product. The production of the connection systems consisting of at least two parts in separate manufacturing systems is itself cost- intensive.

Also known are connection systems in which the separately manufactured parts are not put together for the first time to actually produce the connection, but instead, already in a preparatory work cycle, and the connection then takes place by means of, for example, mutual twisting of the parts in the connecting location of the components. However, even the preparatory work cycle which is intended to make the actual production of a connection of components easier, is very involved and cost-intensive whether done by hand or machine.

Known from the French registered utility model No. 2 464 396 is a connection system consisting of two parts, in which an anchor part is provided with a retaining collar surrounding a central opening and two projecting, spreadable claws, and the second part, which can be inserted into the anchor part, exhibits a rectangular pin and a turning knob connected with same. By means of predetermined breaking points, which can be connecting points or webs, the pin is affixed at its free end to the outer edge of the central opening in the retaining collar of the anchor part. To produce a connection, the anchor part is inserted by its claws into the mutually aligned connection holes of the components to be connected. The second part must then be pressed by its pin into the anchor part, whereby the predetermined breaking points snap. With the aid of the turning knob, the pin can be brought into a position in which, because of its rectangular cross section, it spreads the claws of the anchor part so that an edge that protrudes outward from the claws engages behind the components, and the latter are connected. To loosen the connection, with the aid of the turning knob the pin must again be rotated by 90° so that it assumes a position in which the spreading effect on the claws is removed. The two parts can then be withdrawn from the connecting bore.

Because the two parts are affixed to each other by means of predetermined breaking points, they can at first be handled as a single unit during the first use, and the two parts do not have to be taken from separate parts supplies. Both parts are made of the same elastic plastic, so they can be injected as a unit. Also, the connection location only has to be accessible from one side. What is disadvantageous about this solution as well, however, is that at the connection location itself the part with the rectangular pin has to be pressed into the anchor part only after the anchor part has previously been inserted into the connection holes, before the connection is finally produced by rotating the pin.

The task of the invention is to create a connection system and an inexpensive method for its production, in which the parts are not just affixed to each other, but instead form a true unit even before the first use, and at least during the first use, they form a quasi one-piece connecting means that can be handled as such. It must be possible to use it at connecting locations that are accessible from only one side of the components to be connected. Compared with the state of the art, it should be possible to produce and remove the connection more easily and in fewer steps, i.e., in a time-saving manner, with no damage able to occur to the connection system itself or to the components to be connected. After that, the restoration of the connection or the reuse of the system at another location should be just as uncomplicated.

According to the invention, this is achieved through a production system in which the inner of the two parts that are rotationally movable relative to each other is first cast or injected from a material in a mold, whereupon the outer of the two parts that are rotationally movable relative to each other is cast or injected from a plastic material over the inner part, whereby this inner part is used as a core for the outer part and the two materials chosen for the parts are not adhesive or sticking to each other.

A connection system produced in this way leaves production as a complete unit that can be used immediately, and not as separate individual parts that have to be assembled in a special work cycle or work step before they can be used. Both the production as well as the use of the connection system thus becomes simpler, time-saving and thus less expensive.

A first connection system produced in accordance with this method can consist of an anchor part and an inner pin part that can be twisted onto same, whereby the anchor part exhibits claws that grip the pin of the pin part and that can be spread elastically by means of a rotation of the pin part relative to the anchor part, the pin part as the inner part is made of a hard material and the anchor part as the outer part is made of a comparatively soft, elastic material with restoring force, and the two selected materials are not adhesive or sticking to each other.

Preferably, the anchor part consists of a disk from which two claws that are opposite each other protrude downward, between which the pin of the twistable pin part is held, whereby the pin exhibits a rectangular cross section.

It is advantageous if the twistability of the pin part relative to the anchor part is limited to 90° by limit stops. The pin can thus be reliably brought into both positions, in the one home position of which the claws are not spread, and in the other of which the claws are spread.

In addition, prolongations, which provide the limit stops that limit the twistability of the pin part for stoppers configured on the pin part, can be formed onto the top of the disk of the anchor part along a circular line.

Another connection system produced in accordance with the inventive method consists of an anchor with elastically spread wings that are configured on the bottom of a disk, and with a stem which protrudes from the top of the disk and on which a cap can be twisted.

Preferably, the stem protruding from the anchor is provided with an external thread and the cap exhibits a blind hole with an internal thread.

Anchor and cap are made of different materials that are not adhesive; during production the stem of the anchor is used as a core for the cap.

By way of example, the invention is described in more detail below with the aid of the appended drawing showing the following:

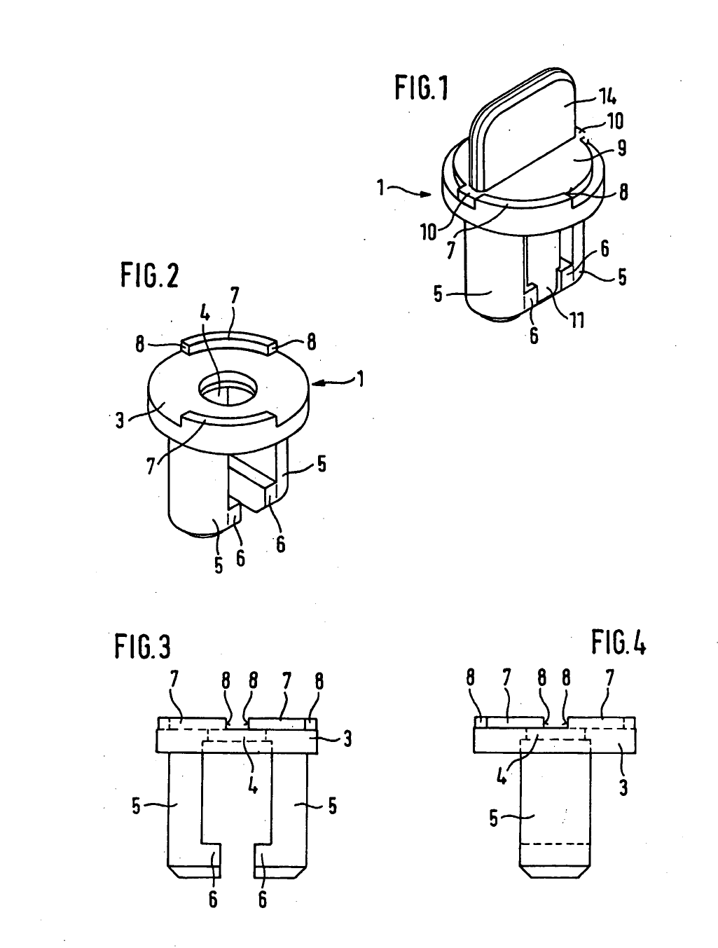

FIG. 1, a perspective representation of a first connection system according to the invention,

FIG. 2, a perspective representation of the anchor part of the connection system according to FIG. 1,

FIG. 3, the view toward the wide side of the anchor part according to FIG. 2,

FIG. 4, the view toward the narrow side of the anchor part according to FIG. 2,

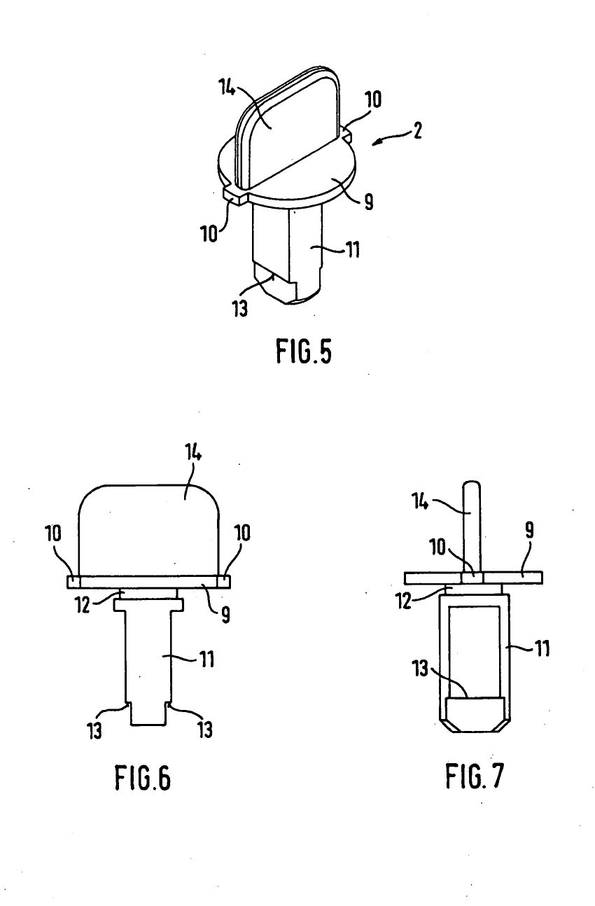

FIG. 5, perspective representation of the pin part of the connection system according to FIG. 1,

FIG. 6, a side view of the pin part according to FIG. 5,

FIG. 7, a side view, rotated by 90° versus FIG. 6, of the pin part according to FIG. 5,

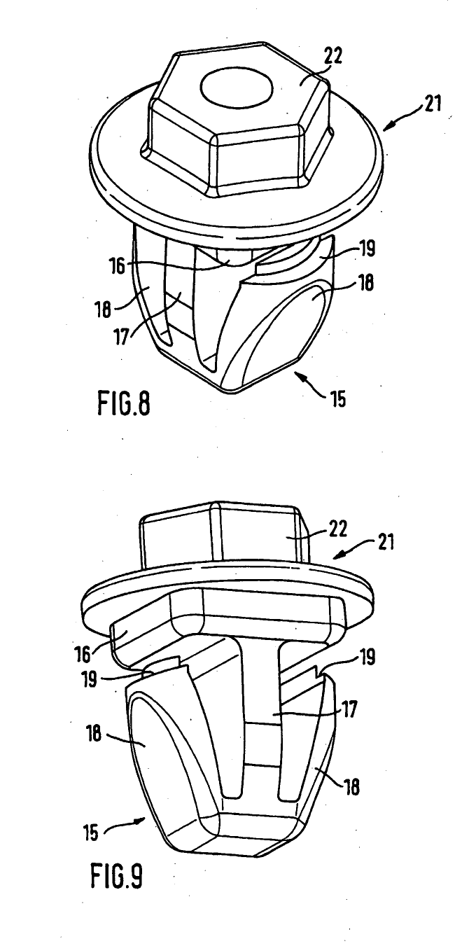

FIG. 8, a first perspective representation of a second connection system according to the invention,

FIG. 9, a second perspective representation of a connection system according to FIG. 8,

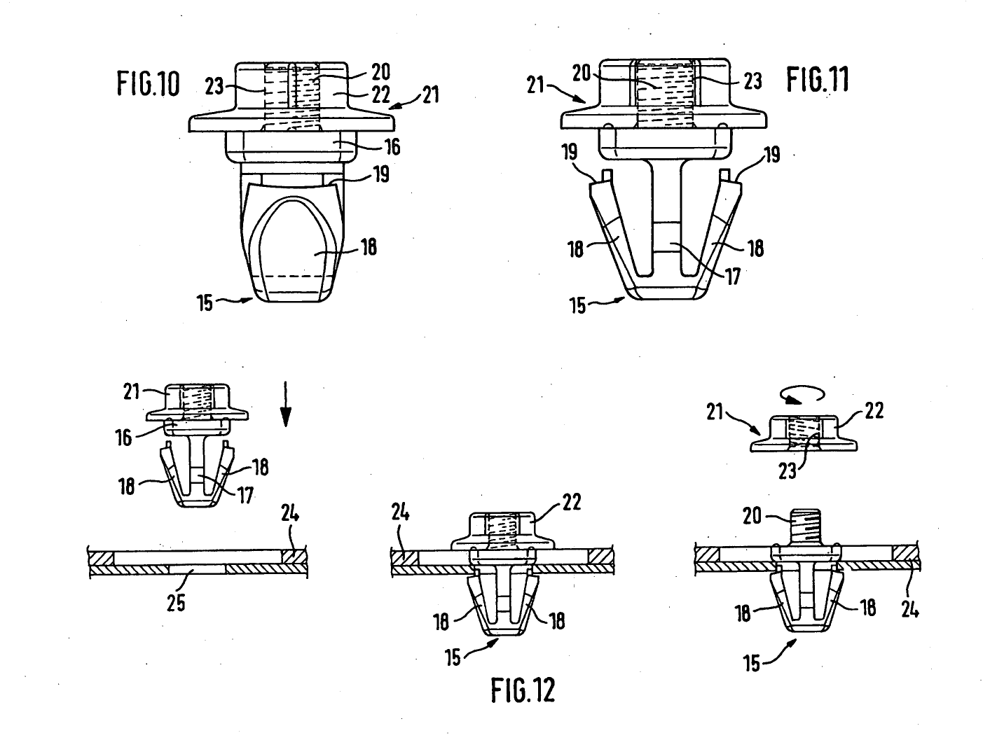

FIG. 10, a first side view of the connection system according to FIG. 8,

FIG. 11, a side view, rotated by 90° versus FIG. 10, of the connection system according to FIG. 8, and

FIG. 12, in three separate representations, the work steps for the first-time production and the loosening of a connection with the aid of a connection system according to FIG. 8.

FIG. 1 shows a first embodiment of a connection system that can be produced according to the method described further below. It consists of an anchor part 1 and a pin part 2, which with the anchor part 1 forms a closed unit in such a way that from outside it appears to be one piece, and can also be handled as such during use. As can be seen more clearly from FIGS. 2 through 4, the anchor part 1 consists of a disk 3 which is provided with a central circular opening 4 and from which two claws 5 that are opposite each other protrude, which are displaced downward and inward and which exhibit on each free end an inward pointing projection 6. Formed onto the top of the disk 3 along a circular line are two prolongations 7 which are opposite each other and which provide limit stops 8 at the end of each. As can be seen from FIGS. 5 through 7, the pin part 2 consists of a circular plate 9 from which two stoppers 10 project laterally and diametrically. Projecting downward from the center of the plate 9 is the pin 11. It has a rectangular cross section, and is connected with the plate 9 by means of a circular, undercut neck section 12; its free end exhibits steps 13 on the wide sides. A rotating grip 14 is formed onto the top of the plate 9.

As can be seen in FIG. 1, the anchor part 1 and the pin part 2 are connected with each other in such a way that the pin 11 of the pin part 2 is located between the claws 5 of the anchor part 1, and the plate 9 lies on the disk 3. The circular neck section 12 is located inside the circular opening 4. With the aid of the rotating grip 14, the pin part 2 can thus be rotated into two positions that are offset by 90°. The rotation is limited in both directions by the limit stop of the stoppers 10 which project laterally from the pin part 2 at the limit stop surfaces 8 of the partial circular prolongations 7 of the anchor part 1. In one of these positions, which can be designated the home position, the pin 11 rests with its lateral steps 13 on the projections 6 of the claws 5, and the narrow side of the stepped end of the pin 2 nearly fills the distance between the projections 6 of the claws 5. If the pin part 2 is rotated by 90° inside the opening 4 of the anchor part 1, the wide side of the stepped pin end goes between the projections 6 of the claws 5, which results in the latter being spread apart.

When the connection system is being used, it is inserted, in its home position with the claws 5 and the pin 11 enclosed between them, into the mutually aligned connection holes of the components to be connected, the pin part 2 is then rotated by 90°, and the connection is then completed and locked with the spreading of the claws 5 that takes place in conjunction with that.

To loosen the connection, the pin part is rotated by 90° back into its home position so that the claws 5 can elastically return into the home position and the connection system can be withdrawn from the connection holes by the rotating grip 14. The connection system remains completely undamaged and unchanged for the production of a new or other connection.

As is shown in FIG. 1, the connection system is produced as a whole in accordance with a special new injection casting method, which can be called forming or over-injection molding method. What is important in this regard is that for the two individual parts that are rotationally movable relative to each other, in this case the anchor part 1 and the pin part 2, two different plastic materials are used that are not adhesive to each other. To do this, the inner part, here the pin part 2, is first cast in a mold from the one material. After this inner part (pin part 2) has solidified, in a second work step the outer part (here the anchor part 1), which is made from the other material that is not adhesive or sticking to the first part, is cast over or around the first part, whereby the first part forms the core for the second part. The mutual twistability of the two parts is thus ensured through the choice of materials, i.e., by their property of not adhering to each other. In addition, the materials for the two parts must be chosen in such a way that they have the correct property for their function. The anchor part 1 is produced from a comparatively soft, elastic material that allows a deformation or spreading of the claws 5, and thus the anchoring of the connection system in the connection location; however, the spreading must also be able to return to its original shape when the spreading force is removed. A stiff material is chosen for the pin part 2 so that the pin 11 can effectively exert this spreading force on the claws 5.

Thus, according to the described method two separate parts are no longer cast which, in a subsequent preparatory work cycle or immediately before their use, have to be assembled first; instead, the complete, immediately usable unit results directly from the casting or injection casting. The assembling work that prepares it for use is spared, and the use itself is made easier and faster.

The mechanical durability or strength of a connection produced with the connection system strongly depends on the shape of the anchor part 1 or its claws 5, which take on or exhibit this shape under the components to be connected. Using the described method, the widest variety of shapes can be developed and produced for the anchor part 1, or for the pin part 2 as well, in order to ensure or improve the durability or strength of the connection achieved through the deformation of the anchor part 1.

FIGS. 8 through 11 show a differently shaped connection system which also consists of two parts that can be twisted relative to each other and which can be produced according to the same method. Here, the anchor 15 consists of a rectangular disk 16 from which a flat arbor 17 projects downward. Extending from the end of this arbor 17 are two wings 18 spreading out in the direction toward the disk 16. A step 19 is provided on the free end of each wing 18. Formed on the top of the disk 16 in the center is a short stem 20 with an external thread (see also FIG. 12 in this regard). A cap 21 with rotating knob 22 exhibits a central blind hole 23 with an internal thread; the cap 21 can thus be rotated on the stem 20.

This connection system is also produced according to the method described above. First, the anchor 15 is cast in a mold, and after the anchor 15 solidifies, the cap 21 is cast over or around the stem 19, whereby the stem 19 with the external thread forms the core so that the blind hole 23 with an internal thread forms by itself inside the cap 21. Anchor 15 and cap 21 are again cast from two different materials that are not adhesive to each other so that the twistability of the cap 21 on the stem 19 is assured. In conjunction with that, the material for the anchor 15 is to be chosen in such a way that the two wings 18 that go out from the tip of the arbor 17 can bend elastically. Anchor 15 and cap 21 are not produced as separate parts that would have to be screwed together, instead, once again the connection system leaves the production process as a complete unit.

The use of this connection system is shown in three separate representations in FIG. 12. In the first picture, two plate-like components 24 can be seen that have continuous connection holes 25 that [word(s) missing in original] on top of each other. In the special case shown, it should be possible later to move the upper component laterally relative to the lower component, for which reason the connection hole 25 of the upper component is configured as an elongated hole. The connection system, exactly as it comes from production, is pushed from above in the direction of the arrow into the connection holes 25 and through them until the disk 16 comes to rest. As that is done, the wings 18 that go out from the tip of the arbor 17 are first bent elastically towards each other in order to spread again after passing through the connection holes 25 and engage under the lower component 24 with their steps 19, as can be seen in the second picture. When this occurs, in this special case the cap 21 comes to rest with its edge on the longitudinal edges of the elongated hole 25 in the upper component 24. The connection is pulled tight by rotating the cap 21. When the disk 16 of the connection system has a rectangular configuration, its side surfaces can advantageously serve as a guide in the elongated hole 25 in the event of possible lateral movement.

In order to loosen the connection as needed, the cap 21 is merely screwed off the stem 20 as shown in the third picture. After that, the upper component can readily be lifted up. In the reverse manner, the connection can later be restored just as readily and easily. The connection system remains intact and reusable.

1. Connecting system with at least on inner and one outer plastic part that are functionally rotatable relative to one another, whereby the inner plastic part or at least a part thereof is the core for the outer plastic part and the two plastic materials are not adherent or adherent to one another, whereby the outer plastic part is an anchor part (1) and the inner plastic part is an inner pin part (2) that is rotatable versus the anchor part (1) and whereby the anchor part (1) exhibits claws (5) which grasps a pin (11) of the anchor part (1) and which are elastically spreadable relative to the anchor part (1) through a rotation of the pin part (2), characterized in that the outer plastic part and the inner plastic part are produced from different plastic materials, whereby the pin part (2) is made of a hard material and the anchor part (1) is made from a comparatively soft, elastic material with restoring force.

2. Connecting system according to claim 1, characterized in that the anchor part (1) consists of a disk (3) from which two claws (5) that are opposite each other project downward, and that the pin (11) of the rotatable pin part (2) is grasped between these claws (5) and exhibits a rectangular cross section.

3. Connecting system according to claim 1, characterized in that the rotatability of the pin part (2) relative tot eh anchor part (1) is limited to 90° by limit stops.

4. Connecting system according to claim 3, characterized in that formed onto the top of the disk (3) of the anchor part (1) are prolongations (7) which follow a circular line and which provide limit stops (8), for stoppers (10) formed on the pin part (2), which limit the rotatability of the pin part (2).

5. Connecting system with at least one inner and one outer plastic part that are functionally rotatable relative to one another, whereby the inner plastic part is an anchor (15), which is configured with elastically spread wings that are configured on the bottom of a disk and with a shaft (20) projecting from the top, on which a cap (21) is rotatable, characterized in that the plastic parts are produced from different plastic materials, whereby the inner plastic part or at least a part thereof is the core for the outer plastic part and the two plastic materials are not adherent or adherent to one another, and that the shaft (20) projecting from the anchor (15) is provided with an outer thread and the cap (21) exhibits a blind hole (23) with an inner thread.

6. Connecting system according to claim 2, characterized in that the rotatability of the pin part (2) relative to the anchor part (1) is limited to 90° by limit stops.
